(19) United States
(12) Patent Application Publication
(10) Pub. No.: US 2026/0175985 A1
(43) Pub. Date: Jun. 25, 2026

(54) PROPULSION ASSEMBLY FOR AIRCRAFT INCLUDING A TURBOJET, A PYLON AND MEANS FOR ATTACHING THE TURBOJET TO THE PYLON

(71) Applicant: Airbus Operations SAS, TOULOUSE (FR)

(72) Inventors: Jérôme CASSAGNE, TOULOUSE (FR); Nicolas JOLIVET, TOULOUSE (FR); Alexandre BELLANGER, TOULOUSE (FR)

(21) Appl. No.: 19/426,703

(22) Filed: Dec. 19, 2025

(30) Foreign Application Priority Data
Dec. 23, 2024 (FR) 2415152

(51) Int. Cl. B64D 27/40; B64D 27/18

(52) U.S. Cl. CPC B64D 27/402; B64D 27/18

(57) ABSTRACT

A propulsion assembly of an aircraft having a longitudinal axis and a vertical median plane and including a front cowling with a rear face perpendicular to the longitudinal axis, a primary structure with a front wall, and an engine attachment including a female yoke member rigidly attached to the front wall, a male yoke member rigidly attached to the rear face and mounted and articulated in the female yolk, a pin rigidly attached to the primary structure and the axis of which is parallel to the longitudinal axis, and a housing in the rear face in which the pin is housed, and wherein the yoke members, the pin and the housing are arranged at the level of the median plane.

### CROSS-REFERENCES TO RELATED APPLICATIONS

This application claims the benefit of French Patent Application Number FR2415152 filed on Dec. 23, 2024, the entire disclosure of which is incorporated herein by way of reference.

### FIELD OF THE INVENTION

The present invention relates to the general field of attaching a turbojet under the wing of an aircraft. It concerns in particular a propulsion assembly including a turbojet, for example of unducted turbofan type, a pylon and an assembly for attaching the turbojet under the pylon. It also concerns an aircraft equipped with such a propulsion assembly.

### BACKGROUND OF THE INVENTION

An aircraft classically includes wings and at least one propulsion assembly fixed under each of said wings. Each propulsion assembly includes an attachment pylon and an engine. The attachment pylon has a rigid structure known as the “primary structure” that is fixed between the wing and the engine by means of attachment assemblies, namely a first attachment assembly between the wing and the attachment pylon and a second attachment assembly between the pylon and the engine.

Although such an engine assembly is effective, the evolution of turbojets is leading to the necessity to develop different attachment pylons.

### SUMMARY OF THE INVENTION

An object of the present invention is to propose a propulsion assembly including a turbojet, a pylon and an attachment device for attaching the turbojet under the pylon.

To this end there is proposed a propulsion assembly of an aircraft, said propulsion assembly having a longitudinal axis and a vertical median plane passing through the longitudinal axis and including:
a turbojet including a front cowling with a rear face perpendicular to the longitudinal axis,
an attachment pylon having a primary structure with a front wall,
an engine attachment including a female yoke member rigidly attached to the front wall, a male yoke member rigidly attached to the rear face and mounted and articulated in the female yoke member, a pin rigidly attached to the primary structure and the axis of which is parallel to the longitudinal axis, and a housing of the rear face in which the pin is housed, and wherein the yoke members, the pin and the housing are arranged at the level of the median plane,
links mounted and articulated between the attachment pylon and the turbojet.

Such an arrangement improves the architecture of the assembly.

The pin is advantageously rigidly attached to a lower stringer of the primary structure.

In a first particular embodiment the propulsion assembly further includes:
two outer links on respective opposite sides of the median plane, where each outer link has a rear end mounted and articulated directly on a lower stringer of the primary structure by a first rear connection point and a front end mounted and articulated directly on the rear face by a first front connection point, and
two inner links on respective opposite sides of the median plane, where each inner link has a rear end mounted and articulated directly on the lower stringer by a second rear connection point and a front end mounted and articulated directly on the rear face by a second front connection point.

Each connection point advantageously takes the form of pivot connection the axis of which is perpendicular to the median plane.

In a second particular embodiment the turbojet includes a rear cowling in which the longitudinal axis constitutes an axis of rotation of the turbojet and the propulsion assembly further includes:
two outer links on respective opposite sides of the median plane, where each outer link has a rear end mounted and articulated on the lower stringer by a first rear connection point and a front end mounted and articulated on the rear face by a first front connection point, and
two inner links on respective opposite sides of the median plane, where each inner link has a rear end mounted and articulated on the lower stringer by a second rear connection point and a front end mounted and articulated on the rear face or on the rear cowling by a second front connection point and where the axes of the inner links converge toward the longitudinal axis.

The propulsion assembly advantageously further includes a fan at the front of the front cowling and the convergence on the longitudinal axis advantageously occurs at the level of the center of the fan.

The front connection points of the outer links are advantageously aligned along a horizontal transverse straight-line segment.

Each connection point of the outer links advantageously takes the form of a pivot connection the axis of which is perpendicular to the median plane.

Each rear second connection point is advantageously fixed directly to the lower stringer.

The invention also proposes an aircraft including a wing and any of the above variants of a propulsion assembly in which the primary structure is fixed under the wing.

### BRIEF DESCRIPTION OF THE DRAWINGS

The features of the invention mentioned hereinabove and others will become more clearly apparent after reading the following description of one embodiment of the invention, said description being given with reference to the appended drawings, in which:

FIG. 1 represents a side view of an aircraft according to the invention,

FIG. 2 is a diagrammatic representation of a first embodiment of a propulsion assembly of the invention in side view,

FIG. 3 is a perspective view of the first embodiment of a propulsion assembly of the invention,

FIG. 4 is a perspective view of a second embodiment of a propulsion assembly of the invention, and

FIG. 5 is a perspective view of the second embodiment of a propulsion assembly of the invention.

### DETAILED DESCRIPTION OF THE PREFERRED EMBODIMENTS

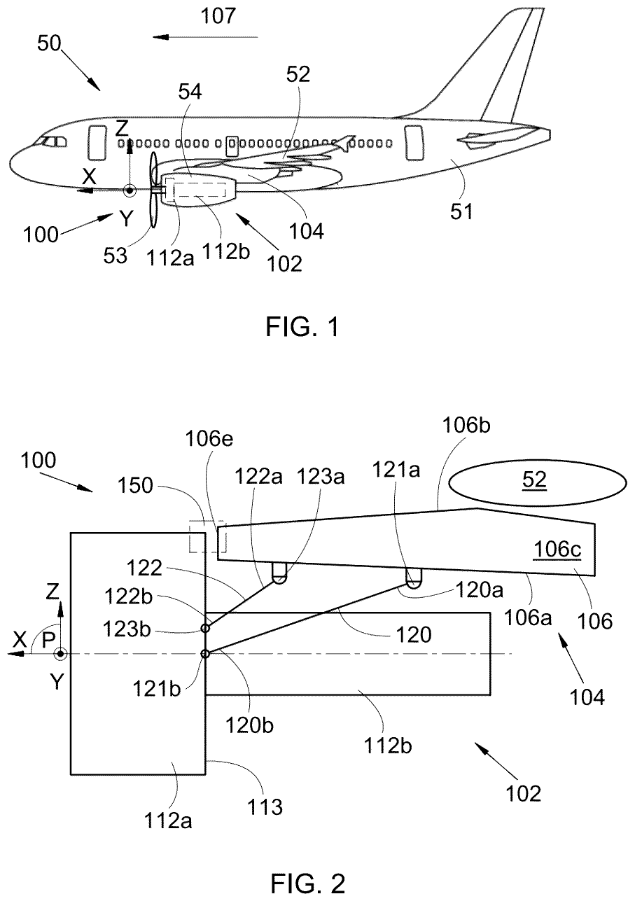

Referring to FIG. 1, an aircraft 50 includes a fuselage 51 to each side of which is fixed a wing 52 under which is mounted at least one propulsion assembly 100 according to the invention.

The propulsion assembly 100, 200 includes an attachment pylon 104 fixed under the wing 52 and a turbojet 102 fixed under the attachment pylon 104. The turbojet 102 is of the unducted turbofan type.

By convention X denotes the longitudinal axis of the turbojet 102 and therefore of the propulsion assembly 100, 200, said longitudinal axis X being parallel to a longitudinal direction of said turbojet 102. Y denotes the transverse axis of the turbojet 102 that is horizontal when the aircraft is on the ground and Z denotes the vertical axis or vertical height when the aircraft is on the ground, these three directions X, Y and Z being mutually orthogonal.

The terms “front” and “rear” are considered relative to a direction of forward movement of the aircraft 50 when the turbojet 102 is functioning, this direction being represented diagrammatically by the arrow 107 in FIG. 1.

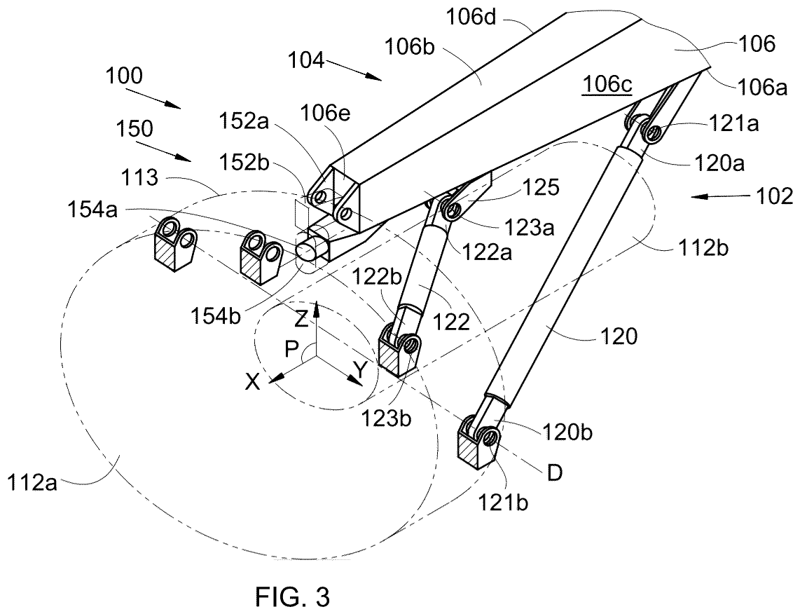

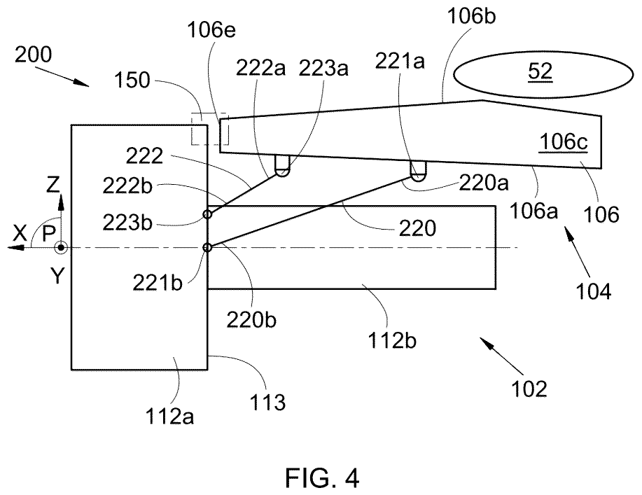

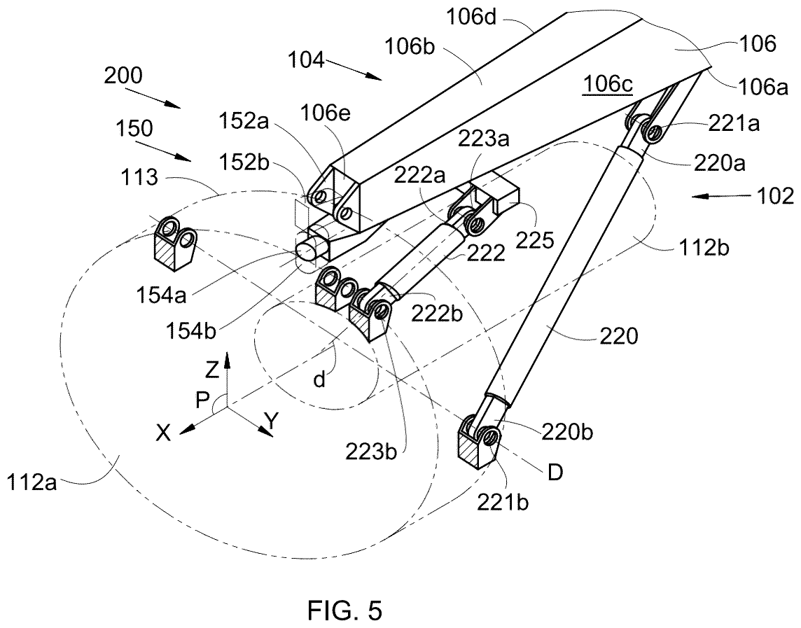

FIG. 2 and FIG. 3 show a first embodiment 100 of the propulsion assembly of the invention and FIG. 4 and FIG. 5 show a second embodiment 200 of the propulsion assembly of the invention.

The turbojet 102 includes from the front toward the rear a fan 53, a nacelle 54 in which are housed the other elements of the turbojet 102 which take the form of a core having a front cowling 112a and a rear cowling 112b that is fixed to the rear of the front cowling 112a and in which the other elements of the turbojet 102 are housed such as compression stages, combustion chambers, turbine stages and a jetpipe. The rear cowling 112b and the front cowling 112a are coaxial with the longitudinal axis X and the rear cowling 112b has a diameter less than that of the front cowling 112a. Here the rear cowling 112b extends from a rear face 113 of the front cowling 112a that is perpendicular to the longitudinal axis X that constitutes an axis of rotation of the turbojet 102.

Here the attachment pylon 104 is represented by its primary structure 106 that is fixed to the structure of the wing 52 by any appropriate attachment means known to the person skilled in the art.

The primary structure 106 takes the form a box section extending in the longitudinal direction X that has a front wall 106e situated at the front of the primary structure 106, a lower stringer 106a extending below the primary structure 106, and an upper stringer 106b extending above the primary structure 106. The primary structure 106 also has two lateral walls 106c-d on respective opposite sides of the vertical median plane P. These various stringers and walls are fixed to one another to form the primary structure 106.

The attachment pylon 104 and the turbojet 102 are globally symmetrical with respect to a vertical median plane XZ of the propulsion assembly 100 that passes through the longitudinal axis X, which plane is referred to hereinafter as the median plane P and separates the attachment pylon 104 and the turbojet 102 into port and starboard parts.

In each of the two embodiments of the invention represented here the propulsion assembly 100, 200 includes an engine attachment 150 that provides the fixing between the front wall 106e of the primary structure 106 and the front cowling 112a, and more particularly the top part of the rear face 113. The engine attachment 150 includes a female yoke member 152a rigidly attached to the front wall 106e and a male yoke member 152b (in chain-dotted line) rigidly attached to the rear face 113 of the front cowling 112a. The male yoke member 152b is mounted in and articulated on the female yoke member 152a by means of a shaft that is not represented.

The axis of the yoke connection is perpendicular to the median plane P. The female yoke member 152a is mounted at the level of the median plane P, which is to say that the two walls of the female yoke member 152a are symmetrical to one another with respect to the median plane P.

The engine attachment 150 also includes a pin 154a also referred to as “spigot” that is cylindrical and is rigidly attached to the primary structure 106 and has a second end that projects forward.

The axis of the pin 154a is in the median plane P and parallel to the longitudinal axis X.

The engine attachment 150 also includes a housing 154b in the rear face 113 in which the pin 154a is housed. The shape of the housing 154b is such that the pin 154a can move therein parallel to the longitudinal axis X and the vertical axis Z but is immobilized parallel to the transverse axis Y.

As specified hereinabove the yoke members 152a-b, the pin 154a and the housing 154b are arranged at the level of the median plane P.

The yoke connection of the engine attachment 150 absorbs forces in X and in Z and the connection between the pin 154a and the housing 154b absorbs forces in Y.

In the particular embodiment shown here the pin 154a is rigidly attached to the lower stringer 106a by fixing a rearward extension of said pin 154a to said lower stringer 106a. In another embodiment that is not represented the pin 154a can be rigidly attached to the front wall 106e.

The two particular arrangements that are described hereinafter employ two outer links 120, 220 and two inner links 122, 222 that produce a first degree hyperstatic system 1 that provides a safety feature, for example in the event of one of the links 120, 122, 220, 222 breaking. Each link 120, 122, 220, 222 also absorbs forces along its axis. The links 120, 122, 220 and 222 are mounted and articulated between the attachment pylon 104 and the turbojet 102.

In the first embodiment of the invention represented in FIGS. 2 and 3 the propulsion assembly 100 therefore includes two outer links 120 on respective opposite sides of the median plane P. Each outer link 120 has a rear end 120a that is mounted and articulated on the lower stringer 106a by a first rear connection point 121a and a front end 120b that is mounted and articulated on the rear face 113 of the front cowling 112a by a first front connecting point 121b.

In the same manner, in the first embodiment of the invention the propulsion assembly 100 includes the two rear links 122 on respective opposite sides of the median plane P. Each inner link 122 has a rear end 122a that is mounted and articulated on the lower stringer 106a by a second rear connection point 123a and a front end 122b that is mounted and articulated on the rear face 113 by a second front connection point 123b.

The inner links 122 are located inside the propulsion assembly 100 with respect to the outer links 120, which are to the exterior of the inner links 122 and extend further rearward relative to the inner links 122.

The second rear connection point 123a is forward of the first rear connection point 121a.

With such an arrangement the links 120 and 122 are moved away from the rear cowling 112b enabling easy access to the interior of the propulsion assembly 100.

In the embodiment of the invention shown here the two front connection points 121b of the outer links 120 are aligned along a transverse straight line segment D that is horizontal and therefore parallel to the transverse axis Y here.

The transverse straight line segment D is here furthermore perpendicular to the median plane P and therefore parallel to the transverse axis Y.

In the embodiment of the invention shown here each connection point 121a-b, 123a-b takes the form of a pivot connection the axis of which is perpendicular to the median plane P, but a different orientation is possible.

To this end each connection point 121a-b, 123a-b takes the form of a yoke type connection with a male yoke member mounted and mobile in rotation in a female yoke member by means of a shaft.

For each front connection point 121b, 123b the female yoke member is rigidly attached to the rear face 113 and the male yoke member consists of the front end 120b, 122b of the link 120, 122 concerned.

For each rear connection point 121a, 123a the female yoke member 125 is rigidly attached to the lower stringer 106a and the male yoke member consists of the rear end 120a, 122a of the link 120, 122 concerned. Here the female yoke member members 125 of the rear connection points 123a of the inner links 122 are fixed directly to the lower stringer 106a.

In the second embodiment of the invention represented in FIGS. 4 and 5 the propulsion assembly 200 therefore includes two outer links 220 on respective opposite sides of the median plane P. Each outer link 220 has a rear end 220a that is mounted and articulated on the lower stringer 106a by a first rear connection point 221a and a front end 220b that is mounted and articulated on the rear face 113 of the front cowling 112a by a first front connection point 221b.

Similarly, in the second embodiment of the invention the propulsion assembly 200 includes two inner links 222 on respective opposite sides of the median plane P. Each inner link 222 has a rear end 222a that is mounted and articulated on the lower stringer 106a by a second rear connection point 223a and a front end 222b that is mounted and articulated on the rear face 113 or the rear cowling 112b by a second front connection point 223b.

The inner links 222 are inside the propulsion assembly 100 relative to the outer links 220 that are outside the inner links 222 and extend further to the rear than the inner links 222.

The second rear connection point 223a is in front of the first rear connection point 221a.

Furthermore the axes of the inner links 222 converge toward the longitudinal axis X. The axis of a link is the axis interconnecting the two ends of the link represented here by the reference ‘d’ in FIG. 3. In a preferred embodiment the convergence on the longitudinal axis X occurs at the level of the center of the fan 53 at the front of the front cowling 112a, that is to say at the intersection between the longitudinal axis X and the plane of the fan 53.

With such an arrangement the inner links 222 converge toward the rotation axis X of the turbojet 102 to minimize said forces.

In the embodiment of the invention described here the two front connection points 221b of the outer links 220 are aligned along a transverse straight line segment D that is horizontal and therefore parallel to the transverse axis Y here.

Here the transverse straight line segment D is moreover perpendicular to the median plane P and therefore parallel to the transverse axis Y.

In the embodiment of the invention described here each connection point 221a-b, 223a-b takes the form of a pivot connection and for the outer links 220 the pivot connection axis is perpendicular to the median plane P, although a different orientation is possible.

To this end each connection point 221a-b, 223a-b takes the form of a yoke type connection with a male yoke member mounted and mobile in rotation in a female yoke member by means of shaft.

For each front connection point 221b of an outer link 220 the female yoke member is rigidly attached to the rear face 113 and the male yoke member consists of the front end 220b of the link 220 concerned. For each front connection point 223b of an inner link 222 the female yoke member is rigidly attached to the rear face 113 or the rear cowling 112b and the male yoke member consists of the front end 222b of the link 222 concerned.

For each rear connection point 221a, 223a the female yoke member is rigidly attached to the lower stringer 106a and the male yoke member consists of the rear end 220a, 222a of the link 220, 222 concerned. Here the female yoke members of the rear connection points 223a of the inner links 222 are fixed to a beam 225 rigidly attached to the lower stringer 106a and projecting laterally from the primary structure 106, but the female yoke member is preferably fixed directly under the lower stringer 106a.

In each of the two embodiments represented here each second rear connection point 123a, 223a is therefore preferably fixed directly to the lower stringer 106a in order inter alia to reduce the width of the attachment pylon 104.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion assembly of an aircraft, said propulsion assembly having a longitudinal axis and a vertical median plane passing through the longitudinal axis, the propulsion assembly comprising:
a turbojet including a front cowling with a rear face perpendicular to the longitudinal axis;
an attachment pylon having a primary structure with a front wall;
an engine attachment including a female yoke member rigidly attached to the front wall, a male yoke member rigidly attached to the rear face and mounted and articulated in the female yoke member, a pin rigidly attached to the primary structure and having an axis parallel to the longitudinal axis, and a housing of the rear face in which the pin is housed, and wherein the male yoke member, the female yolk member, the pin, and the housing are arranged at a level of the median plane;
links mounted and articulated between the attachment pylon and the turbojet;
two outer links on respective opposite sides of the median plane, wherein each outer link has a rear end mounted and articulated directly on a lower stringer of the primary structure by a first rear connection point and a front end mounted and articulated directly on the rear face by a first front connection point; and
two inner links on respective opposite sides of the median plane, wherein each inner link has a rear end mounted and articulated directly on the lower stringer by a second rear connection point and a front end mounted and articulated directly on the rear face by a second front connection point.

2. The propulsion assembly according to claim 1, wherein the pin is rigidly attached directly to the lower stringer of the primary structure.

3. The propulsion assembly according to claim 1, wherein each connection point comprises a pivot connection with an axis perpendicular to the median plane.

4. A propulsion assembly of an aircraft, said propulsion assembly having a longitudinal axis and a vertical median plane passing through the longitudinal axis, and the propulsion assembly comprising:
a turbojet including a front cowling with a rear face perpendicular to the longitudinal axis and a rear cowling in which the longitudinal axis constitutes an axis of rotation of the turbojet;
an attachment pylon having a primary structure with a front wall;
an engine attachment including a female yoke member rigidly attached to the front wall, a male yoke member rigidly attached to the rear face and mounted and articulated in the female yoke member, a pin rigidly attached to the primary structure and having an axis parallel to the longitudinal axis, and a housing of the rear face in which the pin is housed, and wherein the male yoke member, the female yolk member, the pin, and the housing are arranged at a level of the median plane;
links mounted and articulated between the attachment pylon and the turbojet;
two outer links on respective opposite sides of the median plane, wherein each outer link has a rear end mounted and articulated directly on a lower stringer by a first rear connection point and a front end mounted and articulated directly on the rear face by a first front connection point; and
two inner links on respective opposite sides of the median plane, wherein each inner link has a rear end mounted and articulated directly on the lower stringer by a second rear connection point and a front end mounted and articulated directly on the rear face or on the rear cowling by a second front connection point, and wherein axes of the two inner links converge toward the longitudinal axis.

5. The propulsion assembly according to claim 4, wherein the pin is rigidly attached directly to the lower stringer of the primary structure.

6. The propulsion assembly according to claim 4, wherein each connection point comprises a pivot connection with an axis perpendicular to the median plane.

7. The propulsion assembly according to claim 4, further comprising:
a fan at a front of front cowling, and
wherein the axes of the two inner links converge toward the longitudinal axis on the longitudinal axis at a level of a center of the fan.

8. The propulsion assembly according to claim 7, wherein the first front connection points of the two outer links are aligned along a horizontal transverse straight line segment.

9. The propulsion assembly according to claim 8, wherein each connection point of the two outer links comprises a pivot connection having an axis perpendicular to the median plane.

10. The propulsion assembly according to claim 7, wherein each connection point of the two outer links comprises a pivot connection having an axis perpendicular to the median plane.

11. The propulsion assembly according to claim 4, wherein each connection point of the two outer links comprises a pivot connection having an axis perpendicular to the median plane.

12. The propulsion assembly according to claim 4, wherein the first front connection points of the two outer links are aligned along a horizontal transverse straight line segment.

13. An aircraft comprising:
a wing; and
the propulsion assembly according to claim 4, the primary structure of which is fixed under the wing.

14. An aircraft comprising:
a wing; and
the propulsion assembly according to claim 1, the primary structure of which is fixed under the wing.
